(19) United States
(12) Patent Application Publication
(10) Pub. No.: US 2012/0205513 A1
(43) Pub. Date: Aug. 16, 2012

(54) ERGONOMIC SUPPORT PANEL

(76) Inventor: Jesus Salvador Gomez Morales, Leon (MX)

(21) Appl. No.: 13/501,870

(22) PCT Filed: Mar. 26, 2010
(86) PCT No.: PCT/MX2010/000026

§ 371 Date: May 3, 2012

(30) Foreign Application Priority Data
Oct. 14, 2009 (MX) MX/U/2009/000395

(51) Int. Cl. B43L 3/00; F16M 13/00

(52) U.S. Cl. 248/444; 248/346.01

(57) ABSTRACT

An ergonomic panel is provided that is used for writing or drawing on sheets of paper, the panel comprising depressions that rest on the user's arm and abdomen. The panel may be used by a right-handed or a left-handed person.

The present invention refers to a support panel for writing and more concretely refers to a panel to lean ergonomically thereon in order to write thereon, typically using a paper.

In the field of support panels, a great variety thereof exists, the purpose is to provide an adequate support for writing on a paper, which is held in different manners to avoid its movement while writing.

The panels commonly found in the state of the art comprise a substrate, generally made of wood or thin plastic to avoid excessive weight, a clip for holding sheets of paper and some accessories such as clocks, calculators, pencil holders, spacers, etc.

The following documents, from the inventor's point of view, represent the nearest state of the art; Patent application US 2006/0237621 A1 de Wolff et; Patent application US 2009/0019672 To A1 de Moore, titled as panel with clip and improved ergonomics (Clipboard with Improved Ergonomics), describes a board whose main characteristic, is allowing that the sheet of paper may be able to be “moved upwards” to write on its lower part, and is provided with means to hold the paper sheet by means of a spring; AU 306883 S, that shows a board apparently without paper clip or clip for the paper sheet and with depressions on the edges, absolutely for holding the panel while is transported; Great Britain design Number 3022748.

None of the previous documents describes a panel with the ergonomic characteristics of the present invention.

One of the big drawbacks of the panels of the state of the art is its inconvenience during its use to be able to draw or to write independently of whom does the action, whether right or left-handed.

Another disadvantage of the panels of the state of the art consists on not allowing a sufficient strong fixation of the panel to the body to allow safe and fast, writing.

Therefore, it is an object of the present invention to provide a writing panel with ergonomic characteristics that allow a solid writing.

Another object, of the present invention is a panel that allows the correct, firm and comfortable writing for right-hand or left-hand people. This double use is achieved by means of a simple turn of the panel of 180°, and for it, evidently accessories should be changed.

In a modality of the invention, it is not necessary to change the accessories given that the panel includes also the paper sheets holding accessories.

The previous objects are achieved by means of the ergonomic panel of the present invention.

### BRIEF DESCRIPTION OF THE DRAWINGS

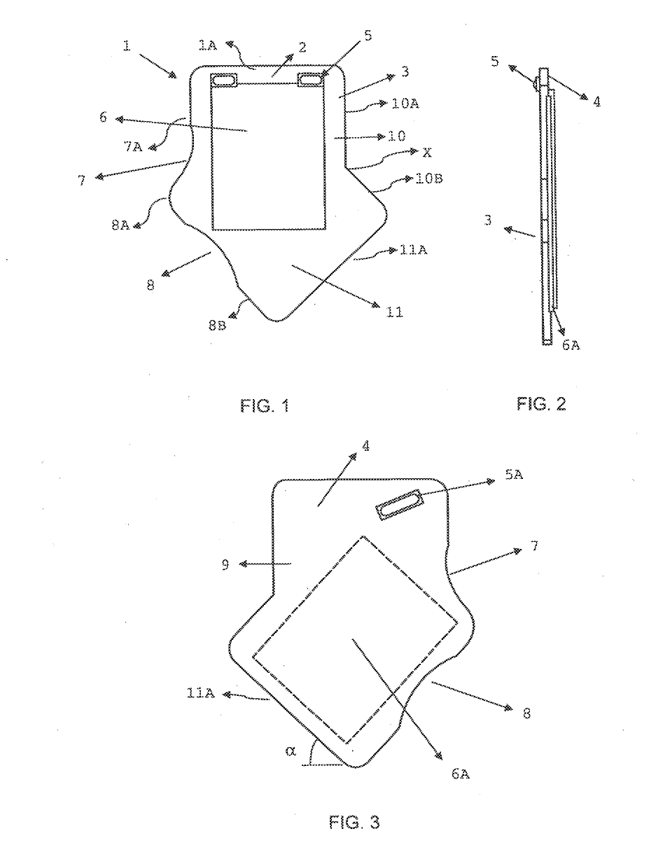

The FIG. 1 is a frontal view of a modality of the panel of the present invention, the accessories that are shown are exemplary only and is not intended to limit the invention to its use.

The FIG. 2 is a lateral view of the same panel,

The FIG. 3 is a rear view of the panel that shows an additional accessory not. found in the state of the art and that comprises a second paper clip to hold the sheet already used.

The invention will be described using the figures attached hereto in which the numeral 1 shows the ergonomic panel that comprise a base 2 manufactured with a sufficiently resistant material laminate for the work proposed, just as wood, aluminum, cardboard, plastic etc, this material should bear the inclusion of some of the following accessories: frontal clip (of any type just as by pressure or magnetic) of sheets of paper 6, 6A stopwatch, pencil holder, rule, compass, calculator, etc., (not shown).

The base 2 comprises a front face 3 and a rear face 4; in the frontal face is placed at least a clip 5 and sheets on which it is desirable to write or draw 6, 6A the sheets holder.

The holders or clips can be of any type provided that they comply the function of holding the amount of sheets desired and that movement thereof is not allowed. As it is shown in the FIG. 3, the rear face 4 of the panel 1 includes an additional holder 5A, placed in the rear face, the holder 5A is used to hold the sheets 6 of the front face 3. The object of this clip is not to interrupt the work that is carried out, doubling simply the sheet and holding it with this paper clip, instead being stopped with the hand or passing it to the rear part of the group of sheets represented by the sheet 6. The location of this paper clip will depend evidently of the position and holding form of the holders 5. Additionally, it has a keeping area for a limited amount of sheets additional to those found in the front face, that allows to have availability of more sheets 6A.

The ergonomics of the panel is appreciated in three fundamental aspects, the elaboration of depression or grooves on the edges of the panel, the distribution of these depressions and the configuration of the same panel.

The depression of the panel are the elements 7 and 8, The element 7 is used to support the left forearm (or right according to the left or right preference of the user) and the 8 to support the abdomen of the user, independently of if he is right or left-handed. In general, the panel is described for right-hand, people unless other is specified.

Contrary to the depression 7, there is a lower zone 9, which will be taken by the palm of the user. Therefore, the panel is held by the zone 9 (see FIG. 3), the depression is supported 7 against the forearm and at the same time against the abdomen of the user in the edge 8, The zone 10, that is located in the upper part of the panel is aimed to place the fingers of the user.

In the zones 10 and 11, additional accessories can be placed such as pencil holders, rules, etc., or compasses or stopwatches or other useful accessories in the tasks of those who use the panels. For example, for an analyst of times and movements special paper sheets will be required for data entry and stopwatches.

The edges of the panel can be protected with elements such as plastic tape or to be rounded to avoid the user to result injured.

With reference to the figure, the panel 1 has an upper edge 1A and two lateral edges 7A and 10A parallel there between and perpendicular to the upper edge 1A. The edge 7A ends where the depression 7 begins, which, as already was explained, is useful as a support for the forearm of the user, upon ending this depression 7, the edge takes another form, now convex to give form to the edge 8A, continuing the descending path, the edge 8A finishes in the point where the depression 8 begins, which will be useful for the user to lean his abdomen thereon. An edge 8B follows which length will, depend on the radio of this depression 8.

This edge 8B joins with the edge 11A, which is completely straight and is arranged with an angle α of approximately 30 to 60° with respect to the edge (1A) (see FIG. 3). The edge 11A joins with the edge 10B, which is a straight edge whose length is smaller to the length of the edge 10A to which it joins to the point X. All these edges and the following ones continuously bind one to each other.

To finish with the description of the panel periphery, keeping the previous order, the edge 1A joins with the edge 1A closing the characteristic contour, of the present panel. Joints among the different edges can be angled or rounded.

1. A panel of ergonomic support that comprises a base (2) that comprises a front face (3), a rear face (4) and an upper edge (1A) wherein it also includes an edge (7A) joined to the edge (1A) , the edge 7A ends where the depression (7) begins, which serves as support for the forearm of the user, upon finishing this depression 7, the edge takes a convex form to originate the edge 8A.

2. The panel according to claim 1, wherein it also comprises an edge 8A which is joined with the depression (8), that is used for the user to lean it against his abdomen, adjacent to the depression (8) the straight edge 8B is located, whose length will depend on the radio of this depression 8, where the edge 83 is joined to the edge (11A).

3. The panel according to claim 2, wherein the edge (11A) is completely straight and is arranged with an angle (a) of approximately 30 to 60° with respect to the edge (1A), the edge (11A) joins with the edge (10B), that is a straight, edge whose length is smaller to the length of the edge (10A) to which it joins in the point X.

4. The panel according to claim 2, wherein edge (10A) joins to the edge (1A) wherein, the joints between the different edges are continuous, and may be of angle or round configuration.

5. The panel according to claim 4, wherein on the upper face accessories are placed such as of sheets, compasses, meters, calculators and sheet holders.

6. The panel according to claim 5, wherein on the lower face a holder 0 is adapted and configured to hold sheets.

7. The panel according to claim 6, wherein the depression (8) is used to support the abdomen of a user independently of being a right or left-handed user.
